(19) United States
(12) Patent Application Publication
(10) Pub. No.: US 2008/0168171 A1
(43) Pub. Date: Jul. 10, 2008

(54) METHOD, SYSTEM AND COMPUTER PROGRAM PRODUCT FOR IMPLEMENTING A SURROGATE CLIENT

(75) Inventors: Genady Grabarnik, Scarsdale, NY (US); Nathaniel Mills, Coventry, CT (US); Larisa Shwartz, Scarsdale, NY (US); Alexander Zlatsin, Yorktown Heights, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/620,735

(22) Filed: Jan. 8, 2007

(51) Int. Cl. G06F 15/16

(52) U.S. Cl. 709/227

(57) ABSTRACT

A method for processing requests from a client to a server, the method comprising: receiving a service request from the client at a service manager implemented on the server; negotiating the type of workflow engine to use between the server and the client; negotiating the type of notification to use between the server and the client; receiving a further service request from the client at the service manager, the further service request using the negotiated type of workflow engine and the negotiated type of notification; creating a surrogate client executing on the server, the surrogate client interfacing the client with a service provider application executing on the server; providing a reference to the surrogate client to the client; the surrogate client receiving requests from the client and forwarding a surrogate request to the service provider application, the surrogate request including a predicted request based on multiple requests from the client; and the surrogate client receiving a notification from the service provider application and forwarding the notification to the client.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates generally to server-client environments and particularly to establishing a surrogate client and interfacing the surrogate client with a client.

2. Description of Background

Client applications often place a high demand on servers that provide services to multiple clients. For example, more and more web applications use dynamic clients that repeatedly generate requests. Examples of such applications include Google Maps, Google Suggest. Dynamic clients use emulation of the asynchronous communication over HTTP (see for example AJAX technology or IXMLHTTPRequest interface). All this technology creates extra load on the server, creating requests once every certain period of time (or upon a user hitting a certain numbers of keys).

In many cases, requests are done to the unchanged data on server. In regular web based applications, client specific information is kept in the sessions (or cookies). Sessions are usually expired after the client disconnects. Cookies are kept on the client and are of restricted size. Regular disconnected clients keep all state info on the client, and the action takes place when client is connected to the server, requiring the server to update data upon connection by the client.

Another possible area of similar problems is long running (or continuing) tasks for the server with results delivered to multiple clients. Examples of such tasks include long running scientific tasks (e.g., weather calculation) or tasks of data mining from information streams. Long running server processing in these cases requires a lot of connection of related resources to be maintained in order to provide information to all clients.

Another problem is that a client may disconnect and connect again during processing. For the long running tasks, the server is expected to have a processing independent of the client connection state and somehow to emulate client requests to the system.

Thus, there is a need in the art for techniques to manage the demands on a server from multiple, dynamic clients.

### SUMMARY OF THE INVENTION

The shortcomings of the prior art are overcome and additional advantages are provided through the provision of a method for processing requests from a client to a server, the method comprising: receiving a service request from the client at a service manager implemented on the server; negotiating the type of workflow engine to use between the server and the client; negotiating the type of notification to use between the server and the client; receiving a further service request from the client at the service manager, the further service request using the negotiated type of workflow engine and the negotiated type of notification; creating a surrogate client executing on the server, the surrogate client interfacing the client with a service provider application executing on the server; providing a reference to the surrogate client to the client; the surrogate client receiving requests from the client and forwarding a surrogate request to the service provider application, the surrogate request including a predicted request based on multiple requests from the client; and the surrogate client receiving a notification from the service provider application and forwarding the notification to the client.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution that reduces burden on servers through implementation of a surrogate client that processes client requests.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a system for implementing a surrogate client;

FIG. 2 illustrates one example of a process of a client interfacing with a surrogate client;

FIG. 3 illustrates one example of processing when a client disconnects from the surrogate client; and

FIG. 4 illustrates one example of processing when a client reconnects with the surrogate client.

The detailed description explains the preferred embodiments of the invention, together with advantages and features, by way of example with reference to the drawings.

### DETAILED DESCRIPTION OF THE INVENTION

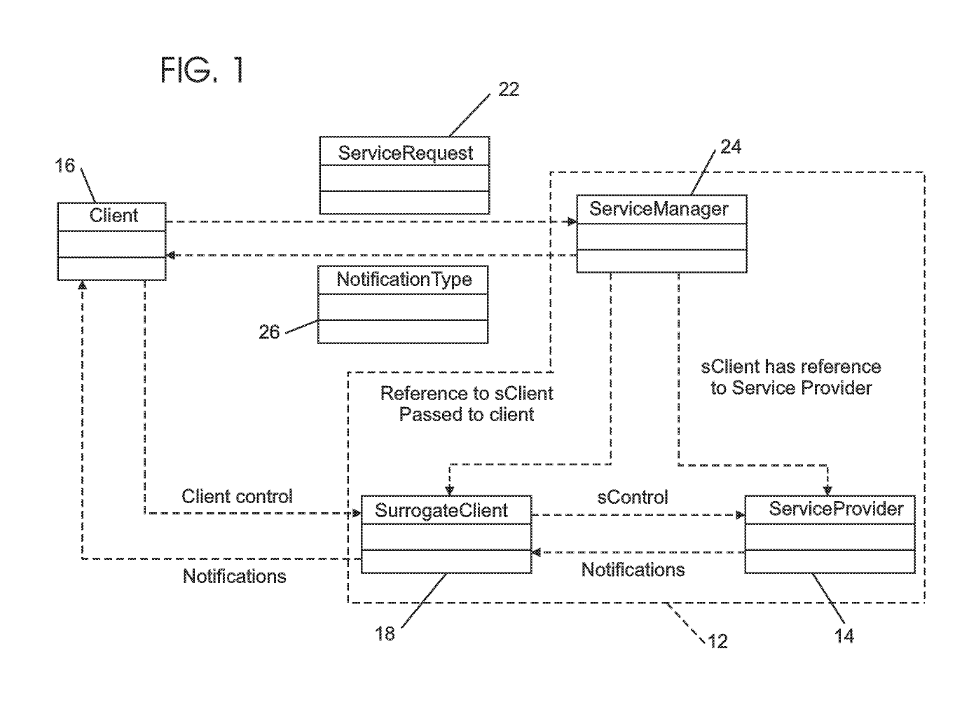

Turning now to the drawings in greater detail, it will be seen that in FIG. 1 there is shown an exemplary system for implementing a surrogate client. The system includes a server 12 that provides services to a client 16. The server 12 implements a service provide application 14 that client 16 contacts for services. The service provider application 14 may be any known application that provides services to a client 16. A service manager 24 negotiates with the client 16 to establish the proper notifications in response to a service request. Further, the service manager 24 creates surrogate client 18 that handles client service requests as described in further detail herein. The service provider application 14, the service manager 24 and the surrogate client 18 may be implemented on a general-purpose computing system executing the operations described herein in response to a computer program code contained in a memory. In operation, the client 16 sends a service request 22 that requests some action from service provider application 14.

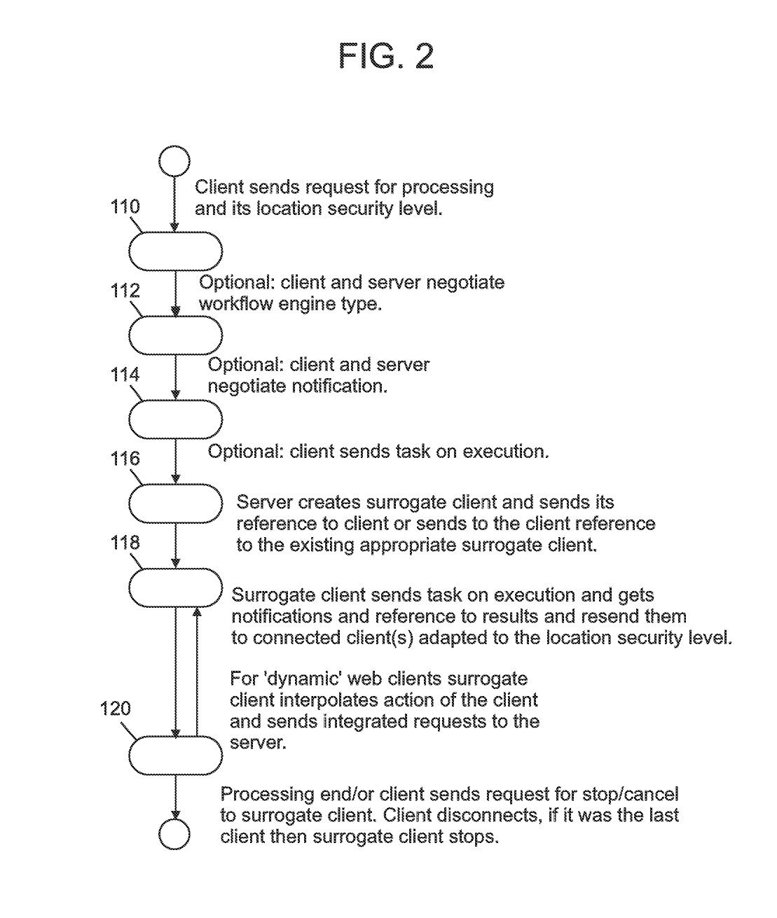

Operation of the system of FIG. 1 is described with reference to FIG. 2. Processing begins at step 110 where client 16 sends a service request for processing by the service provider application 14. The client 16 also provides its location security level so that responses to client 16 have the appropriate security level. The service request 22 is received at the service manager 24. At step 112, the server 12 and client 16 negotiate the type of workflow engine to use. Options for workflow engine include PERL scripting engine or JavaScript scripting engine, ABLE rules engine, etc. Both server 12 and client 16 should support the same workflow engine language. If necessary client 16 may obtain an adapter and adapt requests to be rendered by server 12 in the workflow engine language understood by a server workflow engine. Step 112 is optional as the workflow engine used may be preliminary fixed/hard-coded in the client 16 and server 12.

At step 114, the client 16 and server 12 negotiate the type of notification 26 about processing to be used with the client. Options for notification types include one or more of (i) no notifications, (ii) notifications about the start of the processing and the end of the processing, (iii) notifications about the start, the end, and intermediate processing steps, (iv) notifications based on time elapsed independently from size of work done, and (v) notifications based on size of work done (e.g., notifying client that a portion of the task is complete, notifying client that N items have been found). The negotiation of notification type 26 may be optional as the negotiation type 26 may be pre-defined in the client 16 and server 12.

If either step 112 or step 114 has been implemented, then the client 16 re-sends the service request 22 using the negotiated format at step 116.

At step 118, the service manager 24 creates surrogate client 18 and sends reference to the surrogate client 18 to the client 16. Alternatively, if a surrogate client already exists, the service manager sends reference to an existing appropriate surrogate client. The surrogate client 18 is also given a reference to service provider application 14. The surrogate client 18 then interfaces with the client 16 to reduce demands on service provider application 14.

Processing by the surrogate client 18 is performed at step 120. Surrogate client 18 uses the negotiated workflow type to run tasks from the client. The surrogate client 18 receives a client request (also referred to as a client control) from client 16. When client 16 sends requests to the server 12, the surrogate client 18 sends a surrogate request to service provider application 14. If a notification about task status is generated by the service provider application 14, the service provider application 14 sends the notification to the surrogate client 18. The surrogate client 18 then routes the notification to the client 16 if client 16 is connected. If the client 16 is not connected, notifications are kept by surrogate client 18 until the client reconnects as described further herein.

For the dynamic clients 16 that generate multiple, varying requests, the surrogate client 18 accumulates client requests. Based on a time threshold and/or a number of requests, the surrogate client 18 reacts either on the last request or on some aggregation of the requests. Take, for example, a stream of requests containing coordinates of movements. Requests from the client 16 are provided too frequently to be effectively processed by service provider application 14. The surrogate client 18 may accumulate requests and generate a predicted request as the surrogate request for the service provider application 14. The surrogate client may a variety of techniques to generate the predicted request, such as linear regression prediction, to predict the next request and sends the predicted request to the service provider application 14. The process of FIG. 2 ends when the client 16 sends a request to cancel the session or if the last client disconnects from the surrogate client.

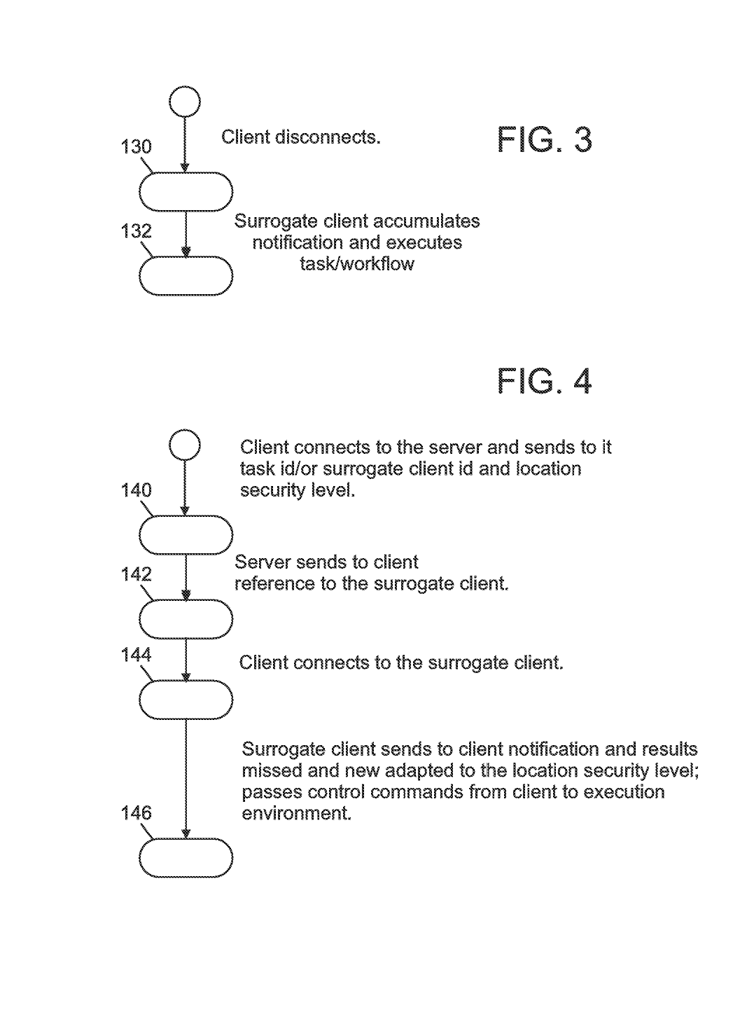

FIG. 3 illustrates processing by the surrogate client 18 when client 16 disconnects at step 130. The surrogate client 18 assumes the client's role in controlling task/ workflow execution and accumulating notifications/ results of processing by service provider application 14. Thus, the surrogate client retains notifications from the service provider that would otherwise be lost when the client 16 disconnects.

FIG. 4 illustrates processing when the client 16 connects to server 12 after being disconnected. During a session, the client 16 keeps an identifier such as a task identifier, client identifier or special identifier to serve as an identification of the surrogate client 18. The client 16 also sends its location security level so that responses from the surrogate client 18 comply with the local security level. Upon reconnecting to the server 12, the client 16 sends the identifier to the server at step 140. At step 142, the server 12 returns reference to the surrogate client 18 to the client 16. The client 16 reconnects to the surrogate client 18 at step 144. At step 146, the surrogate client 18 sends client 16 any missed notifications according to chosen policy. For example surrogate client 18 may send client 16 the last missed notification, all missed notifications or summary of the missed notifications (e.g., a message identifying the number of missed notifications). The responses will be conditioned to comply with any security level indicated by the client. Client 16 then interfaces with the server 12 as described above with reference to FIG. 2.

Embodiments provide a method of processing that emulates the need for the client to be connected during the interaction of client and server. Embodiments are applicable for either long running server processing that requires client requests during processing, or for highly dynamic clients sending frequent client requests. Embodiments improve scalability for the server and increase dynamicity of servers. Embodiments separate client dependent processing from the connection status of the client (i.e., whether client is connected or disconnected). Embodiments allow fractional monitoring by the client during phases when client is connected. Embodiments allow emulation of client requests to the processing system on behalf of the client independently from client connection state. Embodiments allow accumulation of processing system notifications and results, and providing them to the client when client is available (i.e., connected). Embodiments allow the surrogate client to serve multiple clients, and to condition responses to the client complying with a client-identified security level.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for processing requests from a client to a server, the method comprising:
receiving a service request from the client at a service manager implemented on the server;
negotiating the type of workflow engine to use between the server and the client;
negotiating the type of notification to use between the server and the client;
receiving a further service request from the client at the service manager, the further service request using the negotiated type of workflow engine and the negotiated type of notification;
creating a surrogate client executing on the server, the surrogate client interfacing the client with a service provider application executing on the server;
providing a reference to the surrogate client to the client;
the surrogate client receiving requests from the client and forwarding a surrogate request to the service provider application, the surrogate request including a predicted request based on multiple requests from the client; and
the surrogate client receiving a notification from the service provider application and forwarding the notification to the client.

2. The method of claim 1 further comprising:
upon the client ending the session and disconnecting from the server, the surrogate client accumulating notifications from the service provider application.

3. The method of claim 2 further comprising:
upon the client reconnecting with the server, the surrogate client providing the latest accumulated notification from the service provider application to the client.

4. The method of claim 2 further comprising:
upon the client reconnecting with the server, the surrogate client providing all accumulated notifications from the service provider application to the client.

5. The method of claim 2 further comprising:
upon the client reconnecting with the server, the surrogate client providing a summary of accumulated notifications to the client.

6. The method of claim 1 wherein the type of notification used between the server and the client include one or more of (i) no notifications, (ii) notifications about the start of the processing and the end of the processing, (iii) notifications about the start, the end, and intermediate processing steps, (iv) notifications based on time elapsed independently from size of work done, and (v) notifications based on size of work done.

7. The method of claim 1 wherein the predicted request is generated using linear regression prediction.

8. A method for processing requests from a client to a server, the method comprising:
receiving a service request from the client at a service manager implemented on the server;
creating a surrogate client executing on the server, the surrogate client interfacing the client with a service provider application executing on the server;
providing a reference to the surrogate client to the client;
the surrogate client receiving requests from the client and forwarding a surrogate request to the service provider application,
the surrogate client receiving a notification from the service provider application and forwarding the notification to the client.

9. The method of claim 8 wherein the surrogate client interfaces with multiple clients.

10. The method of claim 8 wherein the surrogate client interfaces with the client using the client location security level.

11. The method of claim 8 wherein the surrogate client interfaces with the service provider application regardless of a connection status of the client.

12. The method of claim 8 wherein the surrogate client interfaces with the service provider application to separate the need for client reaction during execution of the client request by the service provider application.
